(19) United States
(12) Patent Application Publication
(10) Pub. No.: US 2008/0085427 A1
(43) Pub. Date: Apr. 10, 2008

(54) Amorphous soft magnetic layers for perpendicular magnetic recording media

(75) Inventors: Erol Girt, Fremont, CA (US); Raj N. Thangaraj, Fremont, CA (US); Qixu Chen, Milpitas, CA (US)

Correspondence Address: SEAGATE TECHNOLOGY LLC;c/o MCDERMOTT WILL & EMERY LLP, 600 13TH STREET, NW, WASHINGTON, DC, 20005-3096, US

(73) Assignee: SEAGATE TECHNOLOGY LLC

(21) Appl. No.: 11/544,632

(22) Filed: Oct. 10, 2006

(51) Int. Cl. G11B 5/66

(52) U.S. Cl. 428/829; 252/62.55

(57) ABSTRACT

A corrosion resistant perpendicular magnetic recording medium comprises: (a) a non-magnetic substrate having a surface; and (b) a layer stack formed over the substrate surface and comprising, in overlying sequence from the surface: (i) a magnetically soft underlayer (SUL); (ii) at least one non-magnetic interlayer; and (iii) at least one magnetically hard perpendicular recording layer; wherein the SUL comprises an FeCo-based alloy material having a composition selected to provide: (1) a substantially amorphous microstructure with a smooth surface in contact with the non-magnetic interlayer; (2) high saturation magnetization Ms greater than about 1.6 T; and (3) corrosion resistance.

### FIELD OF THE INVENTION

The present invention relates to improved, corrosion resistant, high saturation magnetization, magnetically soft amorphous alloys, and to magnetic recording media and methods of manufacturing same. The invention has particular utility in the manufacture and design of high a real recording density magnetic media, such as hard disks, comprising perpendicular magnetic recording layers.

### BACKGROUND OF THE INVENTION

Magnetic media are widely used in various applications, particularly in the computer industry for data/information storage and retrieval applications, typically in disk form, and efforts are continually made with the aim of increasing the a real recording density, i.e., bit density of the magnetic media. Conventional thin-film type magnetic media, wherein a fine-grained polycrystalline magnetic alloy layer serves as the active recording layer, are generally classified as “longitudinal” or “perpendicular”, depending upon the orientation of the magnetic domains of the grains of magnetic material.

Perpendicular recording media have been found to be superior to longitudinal media in achieving very high bit densities without experiencing the thermal stability limit associated with the latter. In perpendicular magnetic recording media, residual magnetization is formed in a direction (“easy axis”) perpendicular to the surface of the magnetic medium, typically a layer of a magnetic material on a suitable substrate. Very high to ultra-high linear recording densities are obtainable by utilizing a “single-pole” magnetic transducer or “head” with such perpendicular magnetic media.

At present, efficient, high bit density recording utilizing a perpendicular magnetic medium requires interposition of a relatively thick (as compared with the magnetic recording layer), magnetically “soft” underlayer (“SUL”), i.e., a magnetic layer having a relatively low coercivity typically not greater than about 1 kOe, such as of a NiFe alloy (Permalloy), between a non-magnetic substrate, e.g., of glass, aluminum (Al) or an Al-based alloy, and a magnetically “hard” recording layer having relatively high coercivity, typically about 3-8 kOe, e.g., of a cobalt-based alloy (e.g., a Co—Cr alloy such as CoCrPtB) having perpendicular anisotropy. The magnetically soft underlayer serves to guide magnetic flux emanating from the head through the magnetically hard perpendicular recording layer.

More specifically, a major function of the SUL is to focus magnetic flux from a magnetic writing head into the magnetically hard recording layer, thereby enabling higher writing resolution than in media without the SUL. The SUL material therefore must be magnetically soft, with very low coercivity, e.g., not greater than about 1 kOe, as indicated above. The saturation magnetization Ms must be sufficiently large such that the flux saturation from the write head is completely absorbed therein without saturating the SUL.

A conventionally structured perpendicular recording system 10 with a perpendicularly oriented magnetic medium 1 and a magnetic transducer head 9 is schematically illustrated in cross-section in FIG. 1, wherein reference numeral 2 indicates a non-magnetic substrate, reference numeral 3 indicates an optional adhesion layer, reference numeral 4 indicates a relatively thick magnetically soft underlayer (SUL), reference numeral 5 indicates an interlayer stack comprising at least one non-magnetic interlayer, sometimes referred to as an “intermediate” layer, and reference numeral 6 indicates at least one relatively thin magnetically hard perpendicular recording layer with its magnetic easy axis perpendicular to the film plane. Interlayer stack 5 may include at least one interlayer 5_{A} of a hcp material adjacent the magnetically hard perpendicular recording layer 6 and an optional seed layer 5_{B} adjacent the magnetically soft underlayer (SUL) 4, comprising an amorphous material.

Still referring to FIG. 1, reference numerals 9_{M} and 9_{A}, respectively, indicate the main (writing) and auxiliary poles of the magnetic transducer head 9. The relatively thin interlayer 5, comprised of one or more layers of non-magnetic materials, serves to (1) prevent magnetic interaction between the magnetically soft underlayer (SUL) 4 and the at least one magnetically hard recording layer 6; and (2) promote desired microstructural and magnetic properties of the at least one magnetically hard recording layer 6.

As shown by the arrows in the figure indicating the path of the magnetic flux φ, flux φ emanates from the main writing pole 9_{M} of magnetic transducer head 9, enters and passes through the at least one vertically oriented, magnetically hard recording layer 6 in the region below main pole 9_{M}, enters and travels within soft magnetic underlayer (SUL) 4 for a distance, and then exits therefrom and passes through the at least one perpendicular hard magnetic recording layer 6 in the region below auxiliary pole 9_{A} of transducer head 9. The direction of movement of perpendicular magnetic medium 21 past transducer head 9 is indicated in the figure by the arrow in the figure.

Completing the layer stack of medium 1 is a protective overcoat layer 7, such as of a diamond-like carbon (DLC), formed over magnetically hard layer 6, and a lubricant topcoat layer 8, such as of a perfluoropolyether (PFPE) material, formed over the protective overcoat layer.

Substrate 2, in hard disk applications, is disk-shaped and comprised of a non-magnetic metal or alloy, e.g., Al or an Al-based alloy, such as Al—Mg having a Ni—P plating layer on the deposition surface thereof, or alternatively, substrate 2 is comprised of a suitable glass, ceramic, glass-ceramic, polymeric material, or a composite or laminate of these materials. Optional adhesion layer 3, if present on substrate surface 2, may comprise a less than about 200 Å thick layer of a metal or a metal alloy material such as Ti, a Ti-based alloy, Ta, a Ta-based alloy, Cr, or a Cr-based alloy. The relatively thick soft magnetic underlayer 4 may be comprised of an about 50 to about 300 nm thick layer of a soft magnetic material such as Ni, Co, Fe, an Fe-containing alloy such as NiFe (Permalloy), FeN, FeSiAl, FeSiAlN, a Co-containing alloy such as CoZr, CoZrCr, CoZrNb, or a Co—Fe-containing alloy such as CoFeZrNb, CoFe, FeCoB, and FeCoC. Relatively thin interlayer stack 5 may comprise an about 50 to about 300 Å thick layer or layers of non-magnetic material(s). Interlayer stack 5 includes at least one interlayer 5_{A} of a hcp material, such as Ta/Ru, TaX/RuY (where X═Ti or Ta and Y═Cr, Mo, W, B, Nb, Zr, Hf, or Re), Ru/CoCrZ (where CoCrZ is non-magnetic and Z=Pr, Ru, Ta, Nb, Zr, W, or Mo) adjacent the magnetically hard perpendicular recording layer 6. When present, seed layer 5_{B} adjacent the magnetically soft underlayer (SUL) 4 may comprise a less than about 100 Å thick layer of an fcc material, such as an alloy of Cu, Ag, Pt, or Au, or an amorphous or fine-grained material, such as Ta, TaW, CrTa, Ti, TiN, TiW, or TiCr. The at least one magnetically hard perpendicular recording layer 6 may comprise an about 10 to about 25 nm thick layer(s) of Co-based alloy(s) including one or more elements selected from the group consisting of Cr, Fe, Ta, Ni, Mo, Pt, W, Cr, Ru, Ti, Si, O, V, Nb, Ge, B, and Pd.

As indicated above, in perpendicular magnetic recording media the soft magnetic underlayer (SUL) 4 is utilized for enhancing/guiding the magnetic field from the read/write transducer head during the recording process, the head field enhancement being proportional to the saturation magnetization Mₛ of the SUL. In this regard, SUL's fabricated of crystalline Fe₁₀₀₋ₓCoₓ, where x is between 30 and 50, have the largest saturation magnetization. Disadvantageously, however, crystalline Fe₁₀₀₋ₓCoₓ SUL's prepared in conventional manner, i.e., by magnetron sputtering, have a significantly larger surface roughness than SUL's fabricated from amorphous materials. On the other hand, low surface roughness of the SUL is required for optimal growth of the at least one magnetically hard recording layer thereover and to minimize the transducer head-to-media spacing (“HMS”). In addition, FeCo-based SUL materials are susceptible to corrosion, and, as a consequence, performance of magnetic media comprising such materials can be substantially degraded over time.

In view of the foregoing, there exists a clear need for improved, corrosion resistant, high saturation magnetization, smooth surfaced (i.e., amorphous) magnetic materials suitable for use as SUL's in perpendicular media which function in optimal fashion and provide a full range of benefits and performance enhancement vis-a-vis conventional longitudinal media and systems, consistent with expectation afforded by adoption of perpendicular media as an industry standard in computer-related applications.

### SUMMARY OF THE INVENTION

An advantage of the present invention is improved, corrosion resistant, amorphous, magnetically soft materials having a smooth surface and high saturation magnetization Ms, suitable for use as magnetically soft underlayers (SUL's) in high areal density perpendicular magnetic recording media.

Another advantage of the present invention is improved high areal density perpendicular magnetic recording media including magnetically soft underlayers comprised of corrosion resistant, amorphous, magnetically soft materials having a smooth surface and high saturation magnetization Ms.

Yet another advantage of the present invention is an improved method of fabricating high areal density perpendicular magnetic recording media including magnetically soft underlayers comprised of corrosion resistant, amorphous, magnetically soft materials having a smooth surface and high saturation magnetization Mₛ.

Additional advantages and other features of the present invention will be set forth in the description which follows and in part will become apparent to those having ordinary skill in the art upon examination of the following or may be learned from the practice of the present invention. The advantages of the present invention may be realized and obtained as particularly pointed out in the appended claims.

According to an aspect of the present invention, the foregoing and other advantages are obtained in part by an improved magnetically soft material comprising an FeCo-based alloy having a composition selected to provide:
(a) an amorphous microstructure with a smooth surface;
(b) high saturation magnetization Mₛ greater than about 1.6 T; and
(c) corrosion resistance.

In accordance with certain preferred embodiments of the present invention, the FeCo-based alloy is an FeCoZr or FeCoZrX alloy, where X is Ta, Nb, Cr, Ru, Rh, or Pt. Preferably, the FeCoZr or FeCoZrX alloy contains more than about 9 at. % Zr, or more than about 6 at. % Zr.

According to other preferred embodiments of the present invention, the FeCo-based alloy is an FeCoBY alloy, where Y is Cr, Ru, Pt, or Rh. Preferably, the FeCoBY alloy contains more than about 13 at. % Cr, Ru, Pt, or Rh, or more than about 10 at. % Cr, Ru, Pt, or Rh.

Another aspect of the present invention is an improved corrosion resistant perpendicular magnetic recording medium, comprising:
(a) a non-magnetic substrate having a surface; and
(b) a layer stack formed over the substrate surface, the layer stack comprising, in overlying sequence from the substrate surface:
   (i) a magnetically soft underlayer (SUL);
   (ii) at least one non-magnetic interlayer; and
   (iii) at least one magnetically hard perpendicular recording layer;

wherein the SUL comprises an FeCo-based alloy material having a composition selected to provide:
(1) an amorphous microstructure with a smooth surface in contact with the at least one non-magnetic interlayer;
(2) high saturation magnetization Ms greater than about 1.6 T; and
(3) corrosion resistance.

According to certain preferred embodiments of the present invention, the FeCo-based alloy is an FeCoZr or FeCoZrX alloy, where X is Ta, Nb, Cr, Ru, Rh, or Pt. Preferably, the FeCoZr or FeCoZrX alloy contains more than about 9 at. % Zr, or more than about 6 at. % Zr.

In accordance with certain other preferred embodiments of the present invention, the FeCo-based alloy is an FeCoBY alloy, where Y is Cr, Ru, Pt, or Rh. Preferably, the FeCoBY alloy contains more than about 13 at. % Cr, Ru, Pt, or Rh, or more than about 10 at. % Cr, Ru, Pt, or Rh.

Yet another aspect of the present invention is an improved method of manufacturing a corrosion resistant perpendicular magnetic recording medium, comprising steps of:
(a) providing a non-magnetic substrate having a surface; and
(b) forming a layer stack over said substrate surface, the layer stack comprising, in overlying sequence from said substrate surface:
   (i) a magnetically soft underlayer (SUL);
   (ii) at least one non-magnetic interlayer; and
   (iii) at least one magnetically hard perpendicular recording layer;

wherein step (b)(i) comprises forming a SUL comprising an FeCo-based alloy material having a composition selected to provide:
(1) an amorphous microstructure with a smooth surface in contact with the at least one non-magnetic interlayer;
(2) high saturation magnetization Ms greater than about 1.6 T; and
(3) corrosion resistance.

According to certain preferred embodiments of the present invention, the FeCo-based alloy is an FeCoZr or FeCoZrX alloy, where X is Ta, Nb, Cr, Ru, Rh, or Pt. Preferably, the FeCoZr or FeCoZrX alloy contains more than about 9 at. % Zr, or more than about 6 at. % Zr.

In accordance with certain other preferred embodiments of the present invention, the FeCo-based alloy is an FeCoBY alloy, where Y is Cr, Ru, Rh, or Pt. Preferably, the FeCoBY alloy contains more than about 13 at. % Cr, Ru, Rh, or Pt, or more than about 10 at. % Cr, Ru, Rh, or Pt.

Additional advantages and aspects of the present disclosure will become readily apparent to those skilled in the art from the following detailed description, wherein embodiments of the present invention are shown and described, simply by way of illustration of the best mode contemplated for practicing the present invention. As will be described, the present invention is capable of other and different embodiments, and its several details are susceptible of modification in various obvious respects, all without departing from the spirit of the present invention. Accordingly, the drawings and description are to be regarded as illustrative in nature, and not as limitative.

### BRIEF DESCRIPTION OF THE DRAWINGS

The following detailed description of the embodiments of the present invention can best be understood when read in conjunction with the following drawings, in which the same reference numerals are employed throughout for designating the same or similar features, and wherein the various features are not necessarily drawn to scale but rather are drawn as to best illustrate the pertinent features, wherein:

FIG. 1 schematically illustrates, in simplified cross-sectional view, a portion of a conventional magnetic recording, storage, and retrieval system comprised of a conventionally structured perpendicular magnetic recording medium and a single-pole magnetic transducer head;

FIG. 2 is a graph illustrating the variation of the net area (thus crystallinity) and 2θ position (in degrees) of the [110] peak of FeCo films as a function of the amount (in at. %) of Zr added to the FeCo films;

FIG. 3 is a graph illustrating the variation of surface roughness (in run) of FeCoZr films as a function of the amount (in at. %) of Zr added to the FeCo films, as well as the surface roughness of a FeCo film with about 13 at. % B added thereto;

FIG. 4 is a graph illustrating the variation of the experimentally measured and estimated saturation magnetizations Ms (in Teslas, T) of FeCoZr and CoZr films as a function of the amount (in at. %) of Zr added thereto;

FIG. 5 is a graph illustrating the variation of the edge corrosion (in %) of FeCoX and FeCoBX films (where X═Zr, Ru, Rh, Cr, or Pt) as a function of the amount (in at. %) of element X added thereto;

FIG. 6 is a graph illustrating the variation of the polarization resistance (thus corrosion resistance) of FeCoB films as a function of the amount of B (in at. %) added thereto and the variation of the polarization resistance of FeCoBX films (where X═Cr or Ru) as a function of the amount (in at. %) of Cr or Ru added thereto; and

FIG. 7 schematically illustrates, in simplified cross-sectional view, a perpendicular magnetic recording medium structured according to the present invention.

### DESCRIPTION OF THE INVENTION

The present invention is based upon recognition by the inventors that the previously described drawbacks and disadvantages of CoFe-based alloy materials utilized as SUL's in high performance, high areal recording density perpendicular magnetic recording media, can be eliminated, or at least substantially reduced, by appropriate selection and control of the amount of alloying element(s) added thereto.

Specifically, the present inventors have determined that amorphous FeCo-based SUL's may be prepared which have a significantly lower surface roughness than conventional crystalline FeCo-based SUL's, which low surface roughness is required for optimal growth of the at least one magnetically hard recording layer thereover and for minimizing the transducer head-to-media spacing (“HMS”) in high performance, high areal density perpendicular magnetic recording media such as described above with reference to FIG. 1. In addition, the present inventors have developed amorphous FeCo-based SUL materials with compositions selected to provide substantially increased resistance to corrosion (relative to differently composed FeCo-based SUL materials), thereby facilitating fabrication of further improved performance perpendicular magnetic media which are free of corrosion-induced degradation over time.

Briefly stated, the present inventors have determined that improved magnetically soft materials comprising FeCo-based alloys are obtained by appropriate selection of the alloy compositions as to provide:
(a) an amorphous microstructure with a smooth surface;
(b) high saturation magnetization Ms greater than about 1.6 T; and
(c) maximum corrosion resistance relative to differently composed FeCo-based SUL materials (as determined via techniques described in detail below).

According to certain preferred embodiments of the present invention, the FeCo-based alloy is an FeCoZr or FeCoZrX alloy, where X is Ta, Nb, Cr, Ru, Rh, or Pt. Preferably, the FeCoZr or FeCoZrX alloy contains more than about 9 at. % Zr or more than about 9 at. % Zr; whereas, according to certain other preferred embodiments of the present invention, the FeCo-based alloy is an FeCoBY alloy, where Y is Cr, Ru, Pt, or Rh and the FeCoBY alloy contains more than about 13 at. % Cr, Ru, Pt, or Rh, or more than about 10 at. % Cr, Ru, Pt, or Rh.

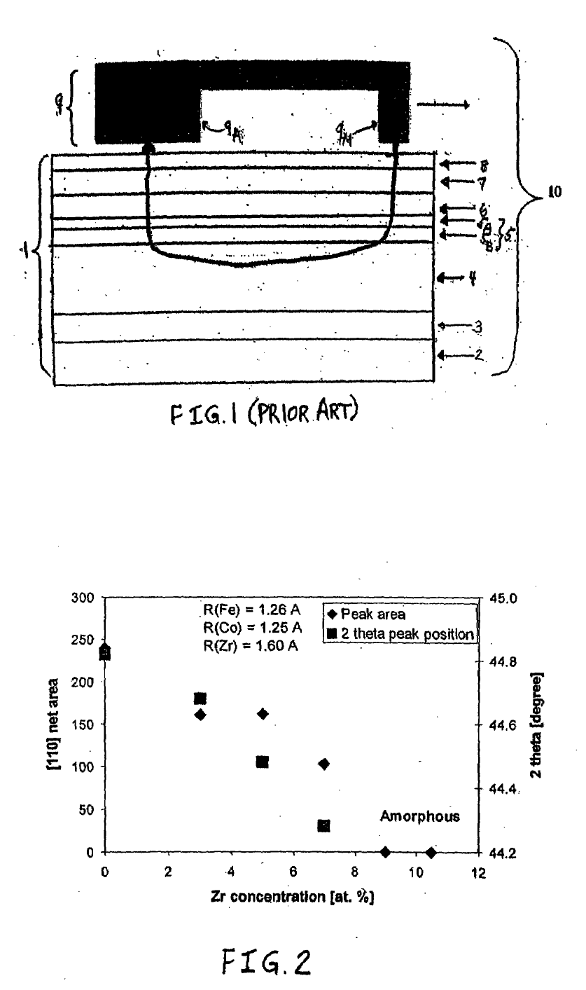

Referring now to FIG. 2, which is a graph illustrating the variation of the net area (thus crystallinity) and 2θ position (in degrees) of the [110] peak of FeCo films as a function of the amount (in at. %) of Zr added to the FeCo films, it is observed that addition of Zr to the FeCo films results in expansion of the crystal lattice, with a shift in the [110] peak (as measured by the 2θ position in degrees) to lower angles, and a loss of crystallinity. In particular, when the amount of Zr added to the CoFe films exceeds from about 6 to about 9 at. %, the films are essentially amorphous. (As defined herein and employed in the appended claims, the expression “amorphous” refers to materials having no long-range order as defined according to conventional principles of crystallography, and may include materials containing nanocrystals. However, while broad peak(s) may be exhibited in X-ray diffraction spectra of the material, sharp peak(s) resulting from crystalline structure is (are) not exhibited in the X-ray diffraction spectra).

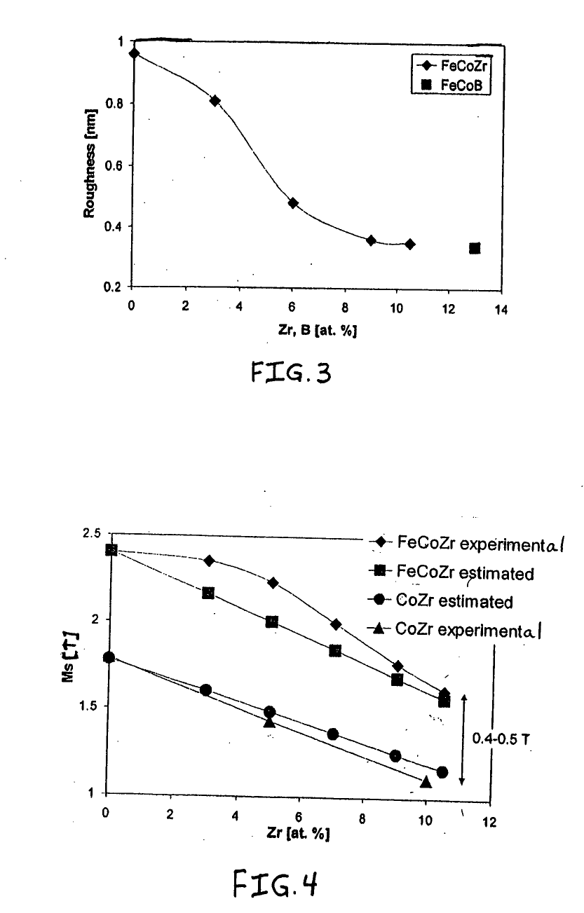

Adverting to FIG. 3, shown therein is a graph illustrating the variation of surface roughness (in nm) of FeCoZr films as a function of the amount (in at. %) of Zr added to the FeCo films, as well as the surface roughness of a FeCo film with about 13 at. % B added thereto. As is evident from the graph, the surface roughness of the FeCoZr films decreases with increasing amount of Zr atoms added thereto, with low surface roughness achieved when the Zr content is at least about 6 at. %, with even lower surface roughness achieved when the Zr content is at or above 9 at. %. In addition, FIG. 3 indicates that FeCoB films containing 13 at. % B also exhibit very low surface roughness less than about 0.4 nm. (As defined herein and employed in the appended claims, the expression “smooth surface” refers to CoFe-based alloy materials, e.g., FeCoZr, with surface roughness, measured in nm, which is at least 50% less than that of CoFe).

With reference to the graph of FIG. 4, illustrated therein is the variation of experimentally measured and estimated saturation magnetizations Mₛ (in Teslas, T) of FeCoZr and CoZr films as a function of the amount (in at. %) of Zr added thereto. According to the results shown therein, addition of Zr atoms to FeCoZr and CoZr films reduces Ms by about 0.06/atom, and the Ms values of the FeCoZr films are consistently about 0.4 T to about 0.5 T larger than the Ms values of CoZr films, indicating greater utility of the FeCoZr films as SUL's in perpendicular magnetic recording media by virtue of their high Ms values (e.g., >˜1.6 T for FeCoZr films containing >˜9 at. % Zr).

Referring to FIG. 5, shown therein is a graph illustrating the variation of the “edge corrosion” (in %) of FeCoX and FeCoBX films (where X═Zr, Ru, Rh, Cr, or Pt) as a function of the amount (in at. %) of element X added thereto. The expression “edge corrosion” refers to the formation of corrosion-induced defects in perpendicular magnetic recording media when the media are exposed to a vapor of 0.5N HCl for 24 hrs. in an enclosed chamber. Perpendicular media having metal constituent layers which are prone to corrosion are vulnerable to formation of this type of defects. Specifically, when the HCl vapor attacks the edges of the media, the metal layers are corroded. Other, non-corroded layers of the media relieve any stress in the media, and gas bubbles are formed in the corroded areas due to hydrogen gas evolution caused by the corrosion process. The bubbles eventually burst when excessive pressure builds up, resulting in a unique morphology of the corroded areas at the media edges. After exposure to HCl vapors, the edge corrosion defects are identified by means of an optical microscope scanned 360° around the edge of the media, and the percent coverage of the defects over the entire circumference is measured.

According to FIG. 5, it is evident that edge corrosion of FeCoX amorphous films or layers is reduced when X═Zr and substantially eliminated when 9 at. % Zr is contained therein, thereby providing significantly enhanced corrosion resistance vis-a-vis differently composed FeCo-based SUL materials. In addition, the data of FIG. 5 reveal that edge corrosion of FeCoBX amorphous films or layers is also reduced when X═Cr and substantially eliminated when ˜10 at. % Cr is contained in therein, again demonstrating the enhanced corrosion resistance of FeCo-based SUL materials according to the present invention.

In view of the foregoing, it is seen that addition of from about 6 to about 9 at. % Zr to FeCo reduces the surface roughness of the layers from about 0.9 nm to a smooth surface having a significantly lower roughness nm while simultaneously improving the corrosion resistance and incurring an acceptable reduction in Ms from about 2.4 T to a still high value of about 1.8 T. By contrast, currently available FeCoBCr and CoZr-based SUL materials are susceptible to corrosion, and have similar surface roughness as the FeCoZr materials of the present invention, but a substantially lower Ms value of about 1.2 T.

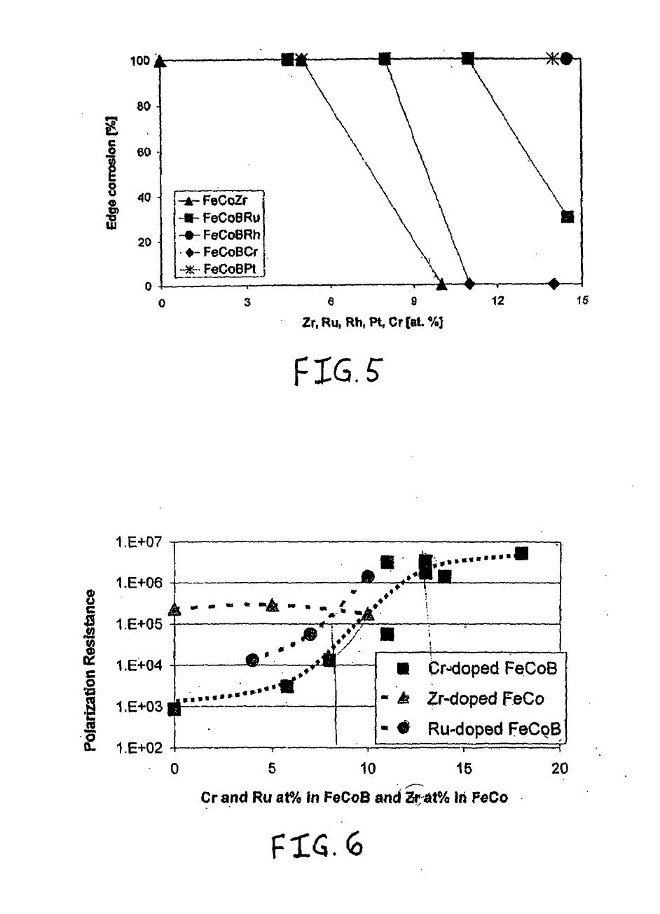

Referring now to FIG. 6, shown therein is a graph illustrating the variation of the “polarization resistance” of FeCoB films as a function of the amount of B (in at. %) added thereto and of FeCoBCr and FeCoBRu films as a function of the amount (in at. %) of Cr or Ru added thereto. According to the “polarization resistance” electrochemical-based technique, the FeCo-based film and Pt-coated Nb serve as anode (test electrode) and cathode, respectively, in a 0.1 N NaCl electrolyte. According to the “electrochemical impedance spectroscopy” (“EIS”) corrosion measurement technique, a constant potential difference is applied between the anode and cathode, e.g., up to 200 mV above the open circuit potential, and a small amplitude AC potential (e.g., 10 mV) is applied to the anode and cathode at frequencies ranging from low (mHz) to high (MHz) frequencies. The resultant AC impedance is measured, and the “polarization resistance” component of the test electrode is deduced using a simple electrical model. When a potential is applied between the FeCo test electrode and the Pt-coated Nb electrode, the test electrode is “polarized”, and the resultant current is proportional to the corrosion rate of the test electrode. That is, for a given applied voltage, if the resultant current is large, the corrosion rate of the test sample is large, and vice versa. Stated differently, when the corrosion current is large, the polarization resistance is low, and vice versa.

The data of FIG. 6 indicate that for FeCoBCr and FeCoBRu films or layers, polarization resistance, hence corrosion resistance, increases with the amount of Cr or Ru in the films or layers. More specifically, when the amount of Cr or Ru exceeds about 13 at. %, the FeCoBCr and FeCoBRu films or layers are essentially corrosion resistant, i.e., they exhibit substantially enhanced corrosion resistance vis-a-vis other, differently composed FeCo-based SUL materials, e.g., those indicated in the figure. On the other hand, addition of Zr to the FeCo-based films or layers did not substantially change the polarization resistance over a fairly wide range of variation of Zr content.

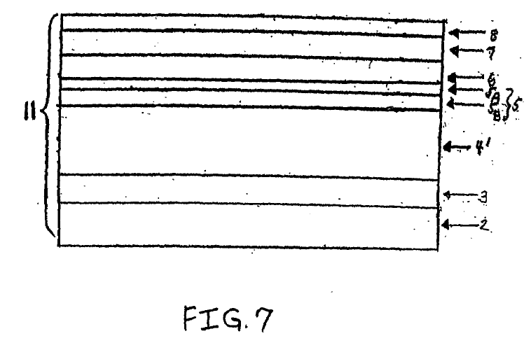

With reference to FIG. 7, schematically illustrated therein, in simplified cross-sectional view, is a portion of a magnetic recording medium 11 according to an illustrative, but non-limitative, embodiment of the present invention. More specifically, medium 11 according to the present invention generally resembles the conventional perpendicular medium 1 of FIG. 1, and comprises a series of thin film layers arranged in an overlying (i.e., stacked) sequence on a non-magnetic substrate 2 comprised of a non-magnetic material selected from the group consisting of: Al, Al-Mg alloys, other Al-based alloys, NiP-plated Al or Al-based alloys, glass, ceramics, glass-ceramics, polymeric materials, and composites or laminates of these materials.

The thickness of substrate 2 is not critical; however, in the case of magnetic recording media for use in hard disk applications, substrate 2 must be of a thickness sufficient to provide the necessary rigidity. Substrate 2 typically comprises Al or an Al-based alloy, e.g., an Al-Mg alloy, or glass or glass-ceramics, and, in the case of Al-based substrates, includes a plating layer, typically of NiP, on the surface of substrate 2 (not shown in the figure for illustrative simplicity). An optional adhesion layer 3, typically a less than about 100 Å thick layer of an amorphous metallic material or a fine-grained material, such as a metal or a metal alloy material, e.g., Ti, a Ti-based alloy, Ta, a Ta-based alloy, Cr, or a Cr-based alloy, may be formed over the surface of substrate surface 2 or the NiP plating layer thereon.

Overlying substrate 2 or optional adhesion layer 3 is a thin magnetically soft underlayer (SUL) 4′ which comprises a layer of a material from about 50 to about 300 nm thick formed of an FeCo-based alloy material as described in detail above, having a composition selected to provide: (1) an amorphous microstructure with a smooth surface in contact with an overlying non-magnetic interlayer 5; (2) high saturation magnetization Mₛ greater than about 1.6 T; and (3) enhanced corrosion resistance. According to certain preferred embodiments of the present invention, the FeCo-based alloy is an FeCoZr or FeCoZrX alloy, where X is Ta, Nb, Cr, Ru, Rh, or Pt and the FeCoZr or FeCoZrX alloy contains more than about 9 at. % Zr or more than about 6 at. % Zr; whereas, according to certain other preferred embodiments of the present invention, the FeCo-based alloy is an FeCoBY alloy, where Y is Cr, Ru, Pt, or Rh and the FeCoBY alloy contains more than about 13 at. % Cr, Ru, Pt, or Rh or more than about 10 at. % Cr, Ru, Pt, or Rh.

As before, an optional adhesion layer 3 may be included in the layer stack of medium 11 between the surface of substrate surface 2 and the SUL 4′, the adhesion layer 3 being less than about 200 Å thick and comprised of a metal or a metal alloy material such as Ti, a Ti-based alloy, Ta, a Ta-based alloy, Cr, or a Cr-based alloy.

Still referring to FIG. 7, the layer stack of medium 11 further comprises a non-magnetic interlayer stack 5 between SUL 4′ and at least one overlying perpendicular magnetic recording layer 6, which interlayer stack 5 is comprised of optional seed layer 5_{A}, and interlayer 5_{B} for facilitating a preferred perpendicular growth orientation of the overlying at least one perpendicular magnetic recording layer 6. Suitable non-magnetic materials for use as interlayer 5_{B} adjacent the magnetically hard perpendicular recording layer 6 include hcp materials, such as Ta/Ru, TaX/RuY (where X═Ti or Ta and Y═Cr, Mo, W, B, Nb, Zr, Hf, or Re), Ru/CoCrZ (where CoCrZ is non-magnetic and Z=Pr, Ru, Ta, Nb, Zr, W, or Mo); suitable materials for use as optional seed layer 5_{A} typically include an amorphous or fine-grained material, such as Ta, TaW, CrTa, Ti, TiN, TiW, or TiCr.

According to embodiments of the present invention, the at least one magnetically hard perpendicular magnetic recording layer(s) 6 is (are) typically comprised of (an) about 10 to about 25 nm thick layer(s) of Co-based alloy(s) including one or more elements selected from the group consisting of Cr, Fe, Ta, Ni, Mo, Pt, W, Cr, Ru, Ti, Si, O, V, Nb, Ge, B, and Pd. Preferably, the at least one perpendicular magnetic recording layer 6 comprises a fine-grained hcp Co-based alloy with a preferred c-axis perpendicular growth orientation; and the interlayer stack 5′ comprises a fine-grained hcp material with a preferred c-axis perpendicular growth orientation. In addition, the at least one perpendicular magnetic recording layer 6 is preferably comprised of at least partially isolated, uniformly sized and composed, magnetic particles or grains with c-axis growth orientation.

Finally, the layer stack of medium 11 includes a protective overcoat layer 7 above the at least one perpendicular magnetic recording layer 6 and a lubricant topcoat layer 8 over the protective overcoat layer 7. Preferably, the protective overcoat layer 7 comprises a carbon-based material, e.g., diamond-like carbon (“DLC”), and the lubricant topcoat layer 8 comprises a fluoropolymer material, e.g., a perfluoropolyether compound.

According to the invention, each of the layers 3, 4′, 5′, 6, 7, as well as the optional seed and adhesion layers (not shown in the figure for illustrative simplicity), may be deposited or otherwise formed by any suitable technique utilized for formation of thin film layers, e.g., any suitable physical vapor deposition (“PVD”) technique, including but not limited to, sputtering, vacuum evaporation, ion plating, cathodic arc deposition (“CAD”), etc., or by any combination of various PVD techniques. The lubricant topcoat layer 8 may be provided over the upper surface of the protective overcoat layer 7 in any convenient manner, e.g., as by dipping the thus-formed medium into a liquid bath containing a solution of the lubricant compound.

Thus, the present invention advantageously provides improved performance, high areal density, magnetic alloy-based perpendicular magnetic media and data/information recording, storage, and retrieval systems, which media include an improved, soft magnetic underlayers (SUL's) which afford improved performance characteristics by virtue of their smooth surfaces, very high Mₛ values, and enhanced corrosion resistance. The media of the present invention enjoy particular utility in high recording density systems for computer-related applications. In addition, the inventive media can be fabricated by means of conventional media manufacturing technologies, e.g., sputtering.

In the previous description, numerous specific details are set forth, such as specific materials, structures, processes, etc., in order to provide a better understanding of the present invention. However, the present invention can be practiced without resorting to the details specifically set forth. In other instances, well-known processing materials and techniques have not been described in detail in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein.

What is claimed is:

1. A magnetically soft material comprising an FeCo-based alloy, said material having a composition selected to provide:
(a) an amorphous microstructure with a smooth surface;
(b) high saturation magnetization Mₛ greater than about 1.6 T; and
(c) corrosion resistance.

2. The material according to claim 1, wherein:
said FeCo-based alloy is an FeCoZr or FeCoZrX alloy, where X is Ta, Nb, Cr, Ru, Rh, or Pt.

3. The material according to claim 2, wherein:
said FeCoZr or FeCoZrX alloy contains more than about 9 at. % Zr.

4. The material according to claim 2, wherein:
said FeCoZr or FeCoZrX alloy contains more than about 6 at. % Zr.

5. The material according to claim 1, wherein:
said FeCo-based alloy is an FeCoBY alloy, where Y is Cr, Ru, Pt, or Rh.

6. The material according to claim 5, wherein:
said FeCoBY alloy contains more than about 13 at. % Cr, Ru, Pt, or Rh.

7. The material according to claim 5, wherein:
said FeCoBY alloy contains more than about 10 at. % Cr, Ru, Pt, or Rh.

8. A corrosion resistant perpendicular magnetic recording medium, comprising:
(a) a non-magnetic substrate having a surface; and
(b) a layer stack formed over said substrate surface, said layer stack comprising, in overlying sequence from said substrate surface:
(i) a magnetically soft underlayer (SUL);
(ii) at least one non-magnetic interlayer; and
(iii) at least one magnetically hard perpendicular recording layer;
wherein said SUL comprises an FeCo-based alloy material having a composition selected to provide:
(1) an amorphous microstructure with a smooth surface in contact with said at least one non-magnetic interlayer;
(2) high saturation magnetization Mₛ greater than about 1.6 T; and
(3) corrosion resistance.

9. The medium according to claim 8, wherein:
said FeCo-based alloy is an FeCoZr or FeCoZrX alloy, where X is Ta, Nb, Cr, Ru, Rh, or Pt.

10. The medium according to claim 9, wherein:
said FeCoZr or FeCoZrX alloy contains more than about 9 at. % Zr.

11. The medium according to claim 9, wherein:
said FeCoZr or FeCoZrX alloy contains more than about 6 at. % Zr.

12. The medium according to claim 8, wherein:
said FeCo-based alloy is an FeCoBY alloy, where Y is Cr, Ru, Pt, or Rh.

13. The medium according to claim 12, wherein:
said FeCoBY alloy contains more than about 13 at. % Cr, Ru, Pt, or Rh.

14. The medium according to claim 12, wherein:
said FeCoBY alloy contains more than about 10 at. % Cr, Ru, Pt, or Rh.

15. A method of manufacturing a corrosion resistant perpendicular magnetic recording medium, comprising steps of:
(a) providing a non-magnetic substrate having a surface; and
(b) forming a layer stack over said substrate surface, said layer stack comprising, in overlying sequence from said substrate surface:
(i) a magnetically soft underlayer (SUL);
(ii) at least one non-magnetic interlayer; and
(iii) at least one magnetically hard perpendicular recording layer;
wherein step (b)(i) comprises forming a SUL comprising an FeCo-based alloy material having a composition selected to provide:
(1) an amorphous microstructure with a smooth surface in contact with said at least one non-magnetic interlayer;
(2) high saturation magnetization Mₛ greater than about 1.6 T; and
(3) corrosion resistance.

16. The method as in claim 15, wherein:
said FeCo-based alloy is an FeCoZr or FeCoZrX alloy, where X is Ta, Nb, Cr, Ru, Rh, or Pt.

17. The method as in claim 16, wherein:
said FeCoZr or FeCoZrX alloy contains more than about 9 at. % Zr.

18. The method as in claim 16, wherein:
said FeCoZr or FeCoZrX alloy contains more than about 6 at. % Zr.

19. The method as in claim 15, wherein:
said FeCo-based alloy is an FeCoBY alloy, where Y is Cr, Ru, Rh, or Pt.

20. The method as in claim 19, wherein:
said FeCoBY alloy contains more than about 13 at. % Cr, Ru, Rh, or Pt.

21. The method as in claim 19, wherein:
said FeCoBY alloy contains more than about 10 at. % Cr, Ru, Rh, or Pt.
